(19) United States
(12) Patent Application Publication
(10) Pub. No.: US 2002/0015863 A1
(43) Pub. Date: Feb. 7, 2002

(54) Method for cleaning a glass substrate for a magnetic recording medium, a glass substrate cleaned by such a method, and a magnetic recording medium using such a substrate

(76) Inventors: Norihiko Nakajima, Nagano (JP); Noboru Kurata, Nagano (JP); Yoshihumi Ajishi, Nagano (JP); Miki Shido, Nagano (JP)

Correspondence Address: MORRISON LAW FIRM, 145 North Fifth Avenue, Mt. Vernon, NY, 10550, US

(21) Appl. No.: 09/841,953

(22) Filed: Apr. 25, 2001

(30) Foreign Application Priority Data
Apr. 26, 2000 (JP) 2000-126594

(51) Int. Cl. C03C 15/00

(52) U.S. Cl. 428/694 ST; 65/31; 134/3

(57) ABSTRACT

Abrasive grains are removed from a glass substrate for a recording medium by washing with water containing an elevated amount of oxygen atoms. The oxygen atoms may be in the form of monatomic diatomic or triatomic molecules. In one embodiment, the oxygen is formed at the anode of an electrolysis apparatus. A small amount of an electrolyte may be used in the electrolysis apparatus without interfering with the ability to clean the glass substrate without generating latent flaws. The invention also is defined as a substrate cleaned by the disclosed method and a magnetic recording medium made from the substrate.

### BACKGROUND

1. Technical field of the invention

The present invention relates to a method for cleaning a substrate for a magnetic recording medium used in a recording device such as fixed magnetic disk. The present invention also relates to a substrate cleaned by such a method for cleaning and a magnetic recording medium using such a substrate.

Magnetic recording media, particularly magnetic disks, are experiencing rapidly increases in recording density. A magnetic disk device is randomly accessed by flying a head over the disk surface and reading recorded data from the disk while it is rotating at high speed. In order to satisfy the demands for both high recording density and high access speed, higher rotating speeds of the disks and smaller flying head heights (the distance between the disk and the head) are required. A substrate of aluminum plated with Nickel-phosphorus (Ni—P) has generally been used as a substrate for a magnetic disk. However, glass substrates are entering into practice. A glass substrate is rigid and is thus unlikely to distort when rotated at high speed. In addition, glass can be given a highly smooth surface.

The process of manufacturing a glass substrate includes a step of polishing the substrate surface. The abrasive grains and polishing powder must be cleaned from the surface of the substrate in the next step. Cleaning is generally done with an acid such as, for example, diluted hydrofluoric acid. After the acid treatment, the acid is removed with alkali. Cleaning with acid tends to roughen the substrate surface due to abnormal etching and the existence of microscopic latent flaws. The rough substrate surface disturbs stable head flight. The latent flaws inhibit normal deposition of functional layers and adversely affects the magnetic property of that portion, resulting in reading and writing errors in those locations. If cleaning with acid is omitted in an attempt to prevent rough surface and latent flaw generation, the abrasive grains and polishing powder are not adequately eliminated and remain on the substrate surface. These residues on the substrate surface disturb stable head flight and cause the errors.

As a further problem, the waste water remaining from acid cleaning contains acid. As a result, liquid-waste treatment must be conducted to satisfy environmental quality standards.

### OBJECTS AND SUMMARY OF THE INVENTION

In view of the foregoing, it is an object of the present invention to provide a method for cleaning a glass substrate for a magnetic recording medium, in which contaminants including abrasive grains and polishing powder generated and attached in the polishing step are eliminated without damaging the surface by exaggerating microscopic latent flaws on the substrate surface.

It is another object of the invention to provide a glass substrate for a magnetic recording medium, wherein the substrate is cleaned by such a method.

It is still another object of the invention to provide a magnetic recording medium using such a glass substrate that has been cleaned by the method.

A first aspect of the present invention is a method for cleaning a glass substrate for a magnetic recording medium using anode water that is produced in an anode side by electrolysis of pure water having a resistivity of at least 10 MΩ-cm. The anode water may include an electrolyte selected from hydrochloric acid, sulfuric acid, nitric acid, phosphoric acid, malic acid, citric acid and succinic acid in a concentration of greater than zero and not more than 100 mM. Alternatively, the method of the invention for cleaning a glass substrate may use water that is prepared by adding oxygen or ozone in a concentration of from 0.1 ppm to 10,000 ppm to pure water having a resistivity of 10 MΩ-cm or more.

A second aspect of the invention involves a glass substrate for a magnetic recording medium that is cleaned by the method for cleaning of the first aspect of the invention.

A third aspect of the invention involves a magnetic recording medium comprising the glass substrate cleaned by the method for cleaning of the first aspect of the invention, a magnetic layer and a protective layer sequentially formed on the glass substrate, and a liquid lubricant layer formed on the protective layer.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic cross sectional view showing a magnetic recording medium according to an embodiment of the present invention.

FIG. 2 is a graph showing the measurement result of the etched mass for the substrates of Examples cleaned according to the invention and the substrates of Comparative Examples cleaned by the methods not of the invention.

FIG. 3 is a graph showing the measurement result of the rate of removal of particles for the substrates of Examples cleaned according to the invention and the substrates of Comparative Examples cleaned by the methods not of the invention.

FIG. 4 is a graph showing the measurement result of the density of latent flaws for the substrates of Examples cleaned according to the invention and the substrates of Comparative Examples cleaned by the methods not of the invention.

FIG. 5 is a graph showing the measurement result of the number of errors after deposition of the functional layers for the substrates of Examples cleaned according to the invention and the substrates of Comparative Examples cleaned by the methods not of the invention.

### DETAILED DESCRIPTION OF THE PREFERRED EMBODIMENT

The first aspect of the invention involves a method for cleaning a glass substrate for a magnetic recording medium. The cleaning liquid used in the cleaning method of the invention is ionic water that is produced at the anode by electrolysis of pure water.

The cleaning liquid is produced by electrolysis. Electrolysis of water is performed in an electrolytic bath having an anode side and cathode side. Separate partitions contain the anode and the cathode. The anode and the cathode are separated by a diaphragm. The cleaning method of the invention uses ionic water developed at the anode side out of the ionic water produced by the electrolysis. The ionic water from the anode side is also referred to as “anode water” in this specification.

The water used in the electrolysis is pure water. The pure water preferably has a resistivity of at least 10 MΩ-cm.

A trace amount of electrolyte may be added to the pure water for stabilizing electrolysis. Anode water obtained by electrolysis of such electrolyte-containing water may be used as the cleaning liquid. Accordingly, anode water containing a predetermined concentration of electrolyte may be used in the method of the invention.

The concentration of electrolyte in the cleaning liquid is preferably as low as possible. If the concentration of the electrolyte is too high, strict liquid-waste treatment becomes necessary, giving rise to the same disposal problem as in the conventional method. Consequently, the concentration of electrolyte in the anode water for use in the cleaning is preferably controlled to be greater than zero and not more than 100 mM. An electrolyte for use in the method of the invention may be selected from any suitable inorganic acid including hydrochloric acid, sulfuric acid, nitric acid, and phosphoric acid, and an organic acid including malic acid, citric acid, and succinic acid, but is not limited to these exemplified substances. The anode water may contain two or more different electrolytes.

A method for cleaning a glass substrate of the invention may use water that is produced by adding oxygen or ozone in a concentration of from 0.1 ppm to 10,000 ppm into pure water having a resistivity of 10 MΩ-cm or more. Hereinafter, the water that is produced by adding oxygen to the pure water is referred to as “oxygen water”. Water that is produced by adding ozone to the pure water is referred to as “ozone water”.

It is clarified in the process of the invention that roughening of the surface and generation of latent flaws are avoided by using above-described anode water, the electrolyte-containing anode water, the oxygen water, or the ozone water in place of acid cleaning liquid.

Although material for a glass substrate of the invention is not limited to particular substances, aluminosilicate glass or soda lime glass may be used. Lithium silicate glass may also be used. A chemically reinforced glass substrate may be used in the invention. The chemically reinforced glass substrate is a glass substrate, on the surface region of which a compressive stress is developed. The compressive stress is produced by substituting an alkaline metal of lithium or sodium with a heavier alkaline metal of sodium or potassium, respectively, by means of immersion in a fused salt, for example.

A step of preparing a glass substrate and a step of cleaning the glass substrate involved with the cleaning method of the invention will be sequentially described in the following. However, the present invention shall not be limited to the exemplified steps.

Preparation of a substrate

A glass substrate is shaped by a known method. The shaped glass substrate is polished with polishing material including cerium oxide and colloidal silica to a desired roughness. The desired roughness may be, for example a surface roughness Ra of from 0.3 to 0.5 nm. The polished glass substrate is then washed and rubbed using neutral detergent and a poly(vinyl alcohol) sponge (a PVA sponge). This produces an unfinished glass substrate.

Cleaning of a glass substrate

The cleaning liquid in the invention is selected from above-described anode water, electrolyte-containing anode water, oxygen water, and ozone water.

A glass substrate is cleaned by immersion cleaning, oscillation cleaning, or a combination of these methods. Other methods, known to one skilled in the art, may be used in combination with the above method. Representative cleaning methods are described below.

1. Oscillation cleaning

In the method of oscillation cleaning, ultrasonic vibration or bubbling is caused in the cleaning liquid to generate small bubbles in the cleaning liquid. Cavitation that arises when the bubbles break and disappear loosens and removes the contaminants from the substrate surface. A cleaning liquid in this cleaning method is selected from above-described cleaning liquid. Oscillation cleaning may be conducted alone, or together with immersion cleaning described below, to improve the ability to eliminate particles from the surface.

The temperature of the cleaning liquid used in the oscillation cleaning is not particularly limited as long as it is below the boiling point of the liquid. A temperature between about 10° C. and about 50° C. is preferable. If enough cleaning effect is achieved by oscillation, the temperature is not necessarily raised. Room temperature is sufficient to obtain adequate cleaning.

Cleaning time is from 1 to 10 minutes, and preferably from 1 to 5 minutes.

2. Immersion cleaning

In the method of immersion cleaning, a glass substrate is immersed in a cleaning liquid. The cleaning liquid is selected from above-described cleaning liquids in the invention:

The temperature of the cleaning liquid used in the immersion cleaning is preferably held in the range from 10° C. to 50° C., although room temperature is usually sufficient to obtain adequate cleaning.

The glass substrate is immersed in the cleaning liquid for 1 to 10 minutes, preferably, 1 to 5 minutes to achieve sufficient cleaning effect.

3. Immersion-oscillation cleaning

Both the immersion cleaning and the oscillation cleaning methods may be applied simultaneously to increase the cleaning effect for the glass substrate. A serial method, in which immersion cleaning is followed by oscillation cleaning, is more effective in removing the particles remaining on the substrate surface.

The temperature and time of the serial cleaning method are the same as those in each of the two methods. Nevertheless, the time duration may be shortened because of the higher efficiency expected from applying both of the immersion and oscillation cleaning procedures.

Other cleaning methods may be applied, in which the cleaning liquid is showered or sprayed to the substrate. In addition, a spinning rinse method or a scrubbing method may be utilized. Cleaning by the shower method delivers cleaning liquid at the rate of 300 to 2,000 ml/min per sheet, for example. Cleaning by the spinning method rotates the substrate at 20 to 300 rpm while delivering cleaning liquid at the rate of 300 to 2,000 ml/min per sheet. Cleaning by the scrubbing method uses a PVA sponge and the cleaning liquid in the invention described above.

In the method for cleaning a glass substrate, the glass substrate is rinsed with a solvent such as pure water to wash away the cleaning liquid away after the substrate is cleaned.

A step of alkali cleaning is conducted in addition to the step of cleaning in the cleaning method of the invention. Specifically, after cleaning using the cleaning liquid in the invention and thoroughly washing off the cleaning liquid, the glass substrate is further cleaned using an alkaline cleaning liquid and then rinsed with a solvent such as pure water to thoroughly wash the alkaline cleaning liquid away. The cleaning liquid for use in the alkali cleaning is not limited to any specific substance. A conventionally used cleaning liquid, for example, 2% KS3030 manufactured by Kao Corporation, may be used. The time and manner of alkali cleaning may be set at the conditions known by one of ordinary skill in the art.

The steps of rinsing after the cleaning step using the cleaning liquid in the invention and after the step of alkali cleaning may be conducted using a solvent such as pure water according to a method known to a person of ordinary skill in the art. Pure water, when used for the rinse, may be pure water having a resistivity of 18 MΩ-cm or more.

Finally, a step of drying the cleaned glass substrate is carried out. Drying may be performed by a vapor-drying process using vapor of isopropyl alcohol (IPA), for example.

A glass substrate, prepared by the process described above is used for each of the evaluations described later.

The number of errors on a magnetic recording medium is measured to evaluate the method for cleaning a glass substrate according to the invention. In order to supply magnetic recording media for the measurement, magnetic recording media were fabricated using the glass substrates cleaned by the cleaning method of the invention. An outline of the fabrication method is described below.

Fabrication of a magnetic recording medium

A magnetic recording medium is fabricated by depositing functional layers including a magnetic layer on a glass substrate cleaned by the cleaning method of the invention.

On the surface of the cleaned glass substrate, a non-magnetic metal layer is formed by sputtering. The non-magnetic metal layer is coated with a non-magnetic under-layer. On the under-layer, a magnetic layer and a protective layer are sequentially formed by sputtering. Finally, a lubricant diluted with a solvent is applied to the surface of the protective layer by dip-coating.

Preferable materials for layers of the medium are: nickel-aluminum (Ni—Al) for the non-magnetic metal layer, chromium (Cr) for the non-magnetic under-layer, cobalt-chromium-platinum (Co—Cr—Pt) alloy for the magnetic layer, and carbon (C) for the protective layer.

Evaluations of the glass substrate and the magnetic recording medium were carried out on the following five items to evaluate the cleaning method of the invention.

Etched mass

A cleaned glass substrate is immersed for 30 minutes in 100 ml of a liquid agent that is each of the cleaning liquid shown in Table 1 of the Examples and Comparative Examples described later. The etched mass is determined by the difference between the mass of the substrate before immersion and after immersion and drying.

When only a small etching effect is measured, this indicates that the cleaning operation has only a small effect on the glass surface.

Composition of the substrate surface

X-ray photoelectron spectroscopy (XPS) is conducted on the surface of a glass substrate and the composition is determined for each of the elements of carbon(C), oxygen(O), silicon (Si), aluminum (Al), sodium (Na), potassium (K), and calcium (Ca). The compositions indicate whether or not the surface condition of the glass substrate varies with the types of cleaning liquid.

Cleaning ability

Cleaning ability is evaluated by the rate of removal of the particles from a substrate surface. The number of particles on the substrate surface after cleaning is counted by means of an optical particle counter. Only particles larger than 0.5 μm are counted. Measured numbers of particles before and after cleaning is compared to obtain the rate of removal of particles.

Measured result of the removal rate indicates the extent to which each of the cleaning methods is capable of removing particles, and hence, the effectiveness of each of the cleaning methods.

Density of latent flaws

The number of latent flaws is measured under an optical microscope at a magnification of ×200. The measurement is conducted on 5 sheets of substrates with 5 view fields per sheet. The measurements are averaged over the 25 view fields. The density of latent flaws is represented by the number of flaws per mm².

The density of latent flaws is preferably not more than one per mm². A high density of latent flaws adversely affects deposition of functional layers and increases the possibility of errors.

Number of errors

The number of errors is measured on the magnetic recording media produced using glass substrates that are cleaned by the method of the invention. The measurement is conducted using a spinstand tester. The number of errors is represented by error bit length per sheet.

Second aspect of the invention

The second aspect of the invention is a glass substrate that is cleaned by a method for cleaning according to the first aspect of the invention.

A glass substrate of the invention is fabricated by the process described in the paragraph Preparation of substrate above, and cleaned by the process described in the section Cleaning of a glass substrate above.

First, a glass substrate is shaped by a conventional method, and polished with polishing material to the desired roughness. The polished glass substrate is then cleaned to obtain a raw glass substrate. Then, the raw glass substrate is cleaned by immersion cleaning, oscillation cleaning, or a combination of these methods using a cleaning liquid of the present invention. The method for preparation of a raw glass substrate and cleaning of the substrate surface is described in more detail earlier in the paragraph entitled Preparation of substrate and in the section entitled Cleaning of a glass substrate.

The material of a glass substrate of the second aspect of the invention is the same as the material described in the place for description of the first aspect of the invention.

Third aspect of the invention

The third aspect of the invention involves a magnetic recording medium that is produced using a substrate cleaned by the first aspect of the invention.

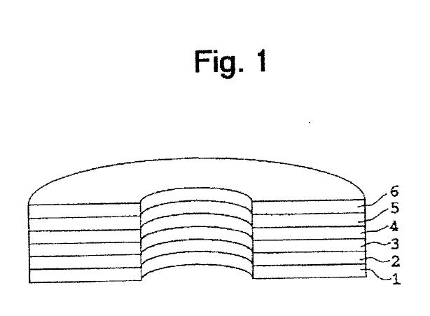

Referring to FIG. 1, a glass substrate 1 of the magnetic recording medium of the invention is cleaned according to the first aspect of the invention. A non-magnetic metal layer 2 is deposited on the surface of the glass substrate 1. A non-magnetic under-layer 3 is deposited on the non-magnetic metal layer 2. A magnetic layer 4 is deposited on the non-magnetic under-layer 3. A protective layer 5 is deposited on the magnetic layer 4. Finally, a liquid lubricant layer 6 is deposited on the surface of the protective layer 5. The result is a finished magnetic recording medium. Conventionally used materials may be used for the non-magnetic metal layer 2, the non-magnetic under-layer 3, the magnetic layer 4, the protective layer 5 and the liquid lubricant layer 6. For example, the non-magnetic metal layer 2 is a metal layer of Ni—Al; the non-magnetic under-layer 3 is made of chromium; the magnetic layer 4 is made of an cobalt alloy, such as a ferromagnetic alloy of Co—Cr—Pt or Co—Cr—Ta; the protective layer 5 is a carbon layer; and the liquid lubricant layer 6 is made of a fluorine-containing lubricant, such as perfluoropolyether lubricant.

Although the magnetic recording medium of the invention has been described referring to FIG. 1, the structure of FIG. 1 is just one example and various modifications are possible. The shape of a magnetic recording medium of the invention may be selected corresponding to the apparatus in which the medium is to be mounted, and is not limited to any specific shape. For example, the disk shape, as illustrated in FIG. 1 is conventionally selected for a magnetic recording medium mounted in a HDD.

A manufacturing method of the magnetic recording medium is described in the following. The manufacturing method comprises a step of forming a glass substrate having a desired shape by machining the glass substrate in a primary form, a step of polishing the glass substrate, a step of cleaning the polished glass substrate, and a step of depositing functional layers for magnetic recording on the cleaned glass substrate. The above-mentioned step of cleaning is performed according to the cleaning method of the first aspect of the invention.

The step of forming a glass substrate in a primary form and the step of polishing the glass substrate are performed according to the methods described earlier in the paragraph entitled Preparation of substrate. A material for the glass substrate 1 may be the same as that described in the description of the first aspect of the invention.

The step of cleaning the glass substrate is described earlier in the section entitled Cleaning of a glass substrate.

The step of depositing functional layers for magnetic recording on the glass substrate 1 comprises processes for forming a non-magnetic metal layer 2 by sputtering, coating the non-magnetic metal layer 2 with a non-magnetic under-layer 3, and forming a magnetic layer 4 and a protective layer 5 sequentially on the under-layer 3. Finally, a lubricant diluted with a solvent is applied on the protective layer 5.

The non-magnetic metal layer 2 is preferably a Ni—Al alloy layer, the non-magnetic under-layer 3 is preferably a chromium layer, and the magnetic layer 4 is preferably a Co—Cr—Pt alloy layer.

The non-magnetic under-layer 3, the magnetic layer 4, and the protective layer 5 may be formed by a sputtering method when these layers are a chromium layer, a Co—Cr—Pt magnetic alloy layer, and a carbon layer, respectively. The protective layer 5 may be a carbon protective layer. A major component of the protective layer may be either usual graphite or a diamond-like carbon. The liquid lubricant layer 6 may be applied by dip-coating or spin-coating.

The thickness of the intermediate layer 2, the non-magnetic under-layer 3, the magnetic layer 4, the protective layer 5, and the liquid lubricant layer 6 may be selected to be the values that are employed in a common magnetic recording medium. The above-described construction of the magnetic recording medium shall not limit the present invention.

[Examples]

The present invention will be described in further detail referring to examples of preferred embodiments thereof.

### EXAMPLE 1

Preparation and cleaning of a substrate

A glass substrate of aluminosilicate was polished using cerium oxide and colloidal silicon to a surface roughness Ra of 0.3 nm to 0.5 nm. The polished glass substrate was then washed and rubbed using neutral detergent and a PVA sponge, to obtain a raw substrate. The raw substrate was soaked in anode water that was prepared by electrolysis of pure water having a resistivity of 18 MΩ-cm and cleaned for 5 minutes while applying ultrasonic vibration at 40 MHz. The substrate was then well rinsed with pure water.

Thereafter, alkali cleaning was done to the substrate. The alkali cleaning was conducted by soaking the glass substrate in an alkaline cleaning liquid at 45° C. of 2% KS3030, manufactured by Kao Corporation, and applying ultrasonic vibration at 40 MHz for 5 min. The substrate was then sufficiently rinsed with pure water having a resistivity of 18 MΩ-cm or more. Finally, the substrate was vapor-dried using IPA vapor. Thus, a cleaned glass substrate was obtained.

A plurality of glass substrates was fabricated by the above method. Some of the substrates were taken for evaluation in the form of a substrate. The remaining substrates were used for producing a plurality of magnetic recording media by the following method.

Producing a magnetic recording medium

On a substrate after completion of the cleaning step, a non-magnetic metal layer of Ni—Al alloy, a non-magnetic under-layer of chromium, a magnetic layer of Co—Cr—Pt alloy, and a carbon protective layer were sequentially formed by a sputtering method. On the carbon protective layer of the obtained disk, a fluorine-containing liquid lubricant, FOMBLIN Z-DOL (a trade name) manufactured by Ausimont, S.p.A, was applied by dip-coating. Thus, a magnetic recording medium was fabricated.

### EXAMPLE 2

A plurality of glass substrates and a plurality of magnetic recording media were fabricated in the same manner as in Example 1 except that anode water containing 0.5 mM of HCl was used for the cleaning liquid.

### EXAMPLE 3

A plurality of glass substrates and a plurality of magnetic recording media were fabricated in the same manner as in Example 1 except that anode water containing 0.25 mM of malic acid was used for the cleaning liquid.

### EXAMPLE 4

A plurality of glass substrates and a plurality of magnetic recording media were fabricated in the same manner as in Example 1 except that oxygen water containing 1,000 ppm of oxygen was used for the cleaning liquid.

### EXAMPLE 5

A plurality of glass substrates and a plurality of magnetic recording media were fabricated in the same manner as in Example 1 except that ozone water containing 1,000 ppm of ozone was used for the cleaning liquid.

Comparative Examples 1 through 4 are described in the following. Cleaning liquids of the Comparative Examples were different from the cleaning liquid in the present invention.

### COMPARATIVE EXAMPLE 1

Preparation and cleaning of a substrate

A glass substrate of aluminosilicate was polished using materials of cerium oxide and colloidal silicon to a surface roughness Ra of 0.3 nm to 0.5 nm. The polished glass substrate was then washed and rubbed using neutral detergent and a PVA sponge, to obtain a raw substrate. The raw substrate was soaked in acid cleaning liquid of 0.05 M hydrofluoric acid and cleaned for 5 minutes while applying ultrasonic vibration at 40 MHz. The substrate was then well rinsed with pure water having a resistivity of 18 MΩ-cm or more.

Thereafter, alkali cleaning was performed on the substrate. The alkali cleaning was conducted by soaking the glass substrate in an alkaline cleaning liquid at 45° C. of 2% KS3030, manufactured by Kao Corporation, and applying ultrasonic vibration at 40 MHz for 5 minutes. The substrate was then rinsed with pure water having a resistivity of 18 MΩ-cm or more. Finally, the substrate was vapor-dried using IPA vapor. Thus, a cleaned glass substrate was obtained.

A plurality of glass substrates was fabricated by the above method. A portion of the substrates was taken for evaluation in the form of a substrate. The remaining substrates were used for producing a plurality of magnetic recording media by the following method.

Producing a magnetic recording medium

On a substrate after completion of the cleaning step, a non-magnetic metal layer of Ni—Al alloy, a non-magnetic under-layer of chromium, a magnetic layer of Co—Cr—Pt alloy, and a carbon protective layer were sequentially formed by a sputtering method. On the carbon protective layer of the obtained disk, a fluorine-containing liquid lubricant, FOMBLIN Z-DOL (a trade name) manufactured by Ausimont, S.p.A, was applied by dip-coating method. Thus, a magnetic recording medium was fabricated.

### COMPARATIVE EXAMPLE 2

A plurality of glass substrates and a plurality of magnetic recording media were fabricated in the same manner as in Comparative Example 1 except that 0.025 M hydrosilicofluoric acid was used for the acid cleaning liquid.

### COMPARATIVE EXAMPLE 3

A plurality of glass substrates and a plurality of magnetic recording media were fabricated in the same manner as in Comparative Example 1 except that 0.05 M hydrochloric acid was used for the acid cleaning liquid.

### COMPARATIVE EXAMPLE 4

A plurality of glass substrates and a plurality of magnetic recording media were fabricated in the same manner as in Comparative Example 1 except that 0.05 M acetic acid was used for the acid cleaning liquid.

The cleaning liquids used in Examples 1 through 5 and Comparative Examples 1 through 4 are summarized in Table 1.

TABLE 1
Cleaning liquid

| | Type of liquid | Additive |
|---|---|---|
| Example 1 | Anode water | — |
| Example 2 | Anode water | 0.5 mM Hcl |
| Example 3 | Anode water | 0.25 mM malic acid |
| Example 4 | Oxygen water | 1,000 ppm oxygen |
| Example 5 | Ozone water | 1,000 ppm ozone |
| Comp. Example 1 | 0.05M hydrofluoric acid | — |
| Comp. Example 2 | 0.025 hydrosilicofluroric acid | — |
| Comp. Example 3 | 0.05M hydrochloric acid | — |
| Comp. Example 4 | 0.05M acetic acid | — |

The thus obtained substrates and magnetic recording media were evaluated on the items described below.

Evaluation method

An outline of the evaluation method is summarized in Table 2.

TABLE 2
Evaluation method of a glass substrate

| No. | Item | Evaluation Method | Specimen |
|---|---|---|---|
| 1 | Etched mass | Mass difference before and after | Glass |
| | | immersion for 30 min. in 100 ml | substrate |
| | | of liquid agent with same | |
| | | composition as cleaning liquid | |
| 2 | Surface | X-ray photoelectron spectroscopy | Glass |
| | composition | (XPS) | substrate |
| 3 | Cleaning ability | Counting particle number on the | Glass |
| | | substrate after cleaning using | substrate |
| | | optical particle counter; particles | |
| | | counted had diameter of at least | |
| | | 0.5 μm | |
| 4 | Density of latent | Counting under optical | Glass |
| | flaws | microscope (X200); averaged | substrate |
| | | over 5 view fields/sheet × 5 | |
| | | sheets | |
| 5 | Number of errors | R/W tester | Magn. |
| | | | record |
| | | | medium |

Evaluation was conducted on items 1 through 5, wherein items 1 through 4 are for evaluation of the glass substrate and item 5 is for evaluation of the magnetic recording medium.

Detail of each evaluation is described below.

Etched mass

A glass substrate was immersed for 30 minutes in 100 ml of a liquid agent that was each of the cleaning liquid shown in Table 1. The etched mass (mg/sheet) was determined by the difference between the mass of the substrate before the immersion and after the immersion and drying. Five sheets of glass substrates were used for the specimens.

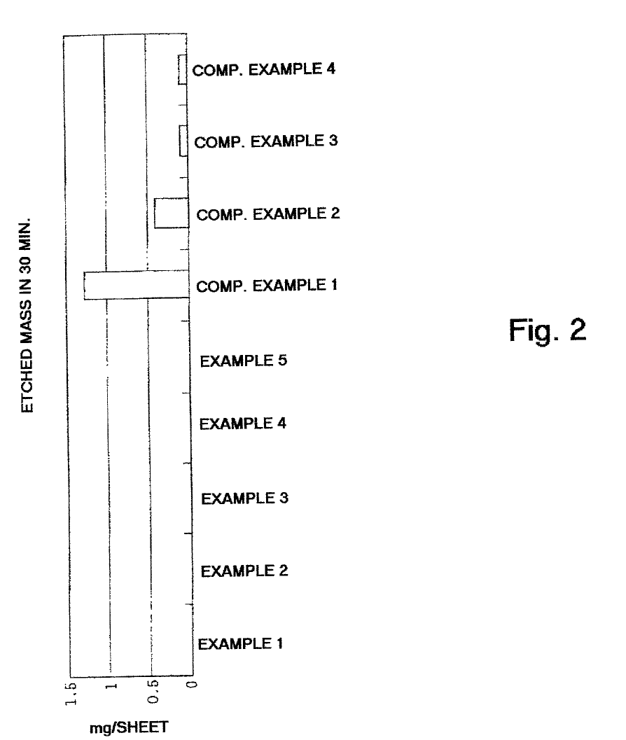

The result is shown in FIG. 2.

As is apparent from FIG. 2, weight loss of a substrate was not observed in any of Examples 1 through 5, in which cleaning was conducted using the anode water, the anode water containing an electrolyte, the oxygen water, or the ozone water. This means that the cleaning in the Examples exhibits little etching effect. Accordingly the occurrence of latent flaws is prevented.

In contrast, weight loss was observed in Comparative Examples 1 through 4, in which cleaning was conducted using an acid solution as a cleaning liquid. The weight loss was significant in Comparative Examples 1 and 2, in which hydrofluoric acid and hydrosilicofluoric acid were used respectively, as the cleaning liquid. In the Comparative Examples 3 and 4 using hydrochloric acid and acetic acid, respectively, the weight loss was measurable but was relatively small. Because dissolving of the substrate material in the locations of microscopically inhomogeneous composition of the glass material the dissolving in the inhomogeneous locations acts differently than does the dissolving in the remaining normal portion. Thus, the observation of weight loss or the occurrence of dissolution indicates that there is an increased probability of latent flaw generation.

Composition of the substrate surface

X-ray photoelectron spectroscopy (XPS) was conducted on the surface of a glass substrate after cleaning and drying, and the composition was determined.

The result is shown in Table 3.

TABLE 3
Surface composition measured by XPS (%)

| | C | O | Si | Al | Na | K | Ca |
|---|---|---|---|---|---|---|---|
| Example 1 | 4.2 | 55.4 | 32.5 | 6.2 | 0.3 | 0.8 | 0.6 |
| Example 2 | 4.1 | 55.8 | 31.7 | 6.7 | 0.3 | 0.9 | 0.5 |
| Example 3 | 4.6 | 54.1 | 32.7 | 6.9 | 0.3 | 0.9 | 0.5 |
| Example 4 | 4.2 | 55.2 | 32.2 | 6.7 | 0.30 | 0.8 | 0.6 |
| Example 5 | 4.6 | 54.7 | 32.4 | 6.6 | 0.3 | 0.8 | 0.6 |
| Comp. Example 1 | 5.8 | 57.8 | 35.3 | 0.9 | 0.2 | 0.0 | 0.0 |
| Comp. Example 2 | 6.1 | 57.5 | 36.4 | 0.0 | 0.0 | 0.0 | 0.0 |
| Comp. Example 3 | 5.6 | 55.5 | 31.7 | 5.7 | 0.3 | 0.8 | 0.4 |
| Comp. Example 4 | 5.2 | 55.1 | 31.5 | 6.6 | 0.3 | 0.9 | 0.4 |

As shown in Table 3, Na and K, which are alkali metals, and Ca were either not detected, or were very little detected with in Comparative Examples 1 and 2, in which hydrofluoric acid and hydrosilicofluoric acid were used respectively for cleaning liquid. This result is much different from the result with Examples 1 through 5 and Comparative Examples 3 and 4. The result shows that the alkali metals and calcium in the Comparative Examples 1 and 2 were selectively dissolved out of the glass surface, and the surface condition was changed.

Cleaning ability

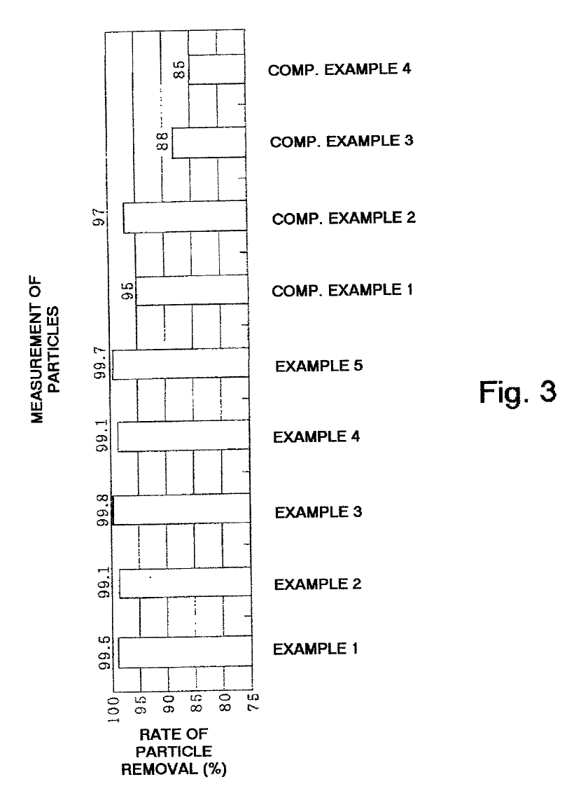

Cleaning ability was evaluated by the rate of removal of the particles on a substrate surface. The number of particles on the substrate surface remaining after cleaning was counted by an optical particle counter. Only particles larger than 0.5 μm were counted. The measured numbers of particles before and after cleaning were compared to obtain the rate of removal of particles. The result is shown in FIG. 3.

As is clearly shown in FIG. 3, the particles were nearly completely removed by cleaning with anode water, with anode water containing an electrolyte, with oxygen water, and with ozone water according to the invention. On the other hand, the rate of particle removal was lower in Comparative Examples 1 and 2, in which hydrofluoric acid and hydrosilicofluoric acid were used respectively for cleaning liquid, and also lower in Comparative Examples 3 and 4, in which hydrochloric acid and acetic acid were used respectively for cleaning liquid, as compared to the removal rate in the Examples of the invention. In particular, the invented method is much superior to the methods in Comparative Examples 3 and 4.

Density of latent flaws

The number of latent flaws was measured under an optical microscope at a magnification of ×200. The measurement was conducted on 5 sheets of substrates with 5 view fields per sheet, and averaged over the 25 view fields. The density of latent flaws is represented by number of flaws per mm².

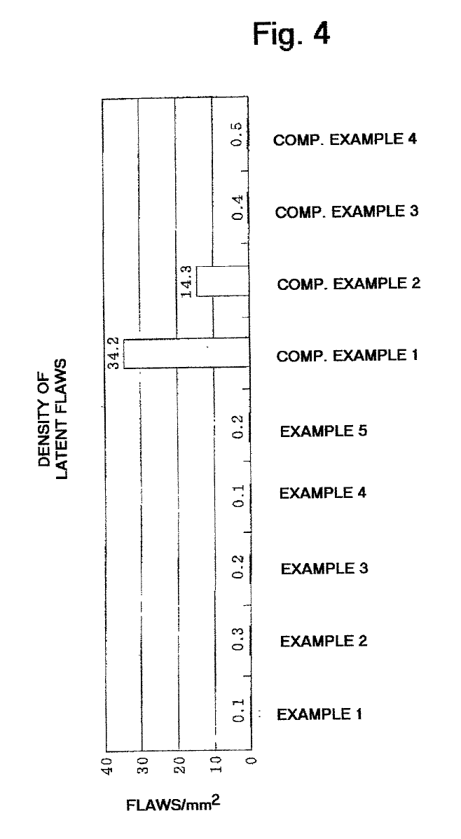

The result of the measurement of the density of latent flaws is shown in FIG. 4. The density of latent flaws was much lower in the substrates of Examples 1 through 5, which were cleaned according to the invention, than in the substrates of Comparative Examples 1 and 2. The density of latent flaws in the glass substrates cleaned by the method of invention was not more than one flaws per mm², which is a favorable result.

The result showing that the density of latent flaws was high in Comparative Examples 1 and 2, agrees with the result for etched mass described earlier.

Number of errors

The number of errors was measured on magnetic recording media produced according to the Examples and the Comparative Examples. The measurement was conducted using an R/W (read/write) tester. The number of errors was represented by error bit length per sheet. The measurement was carried out on 25 sheets of magnetic recording media for each Example or Comparative Example.

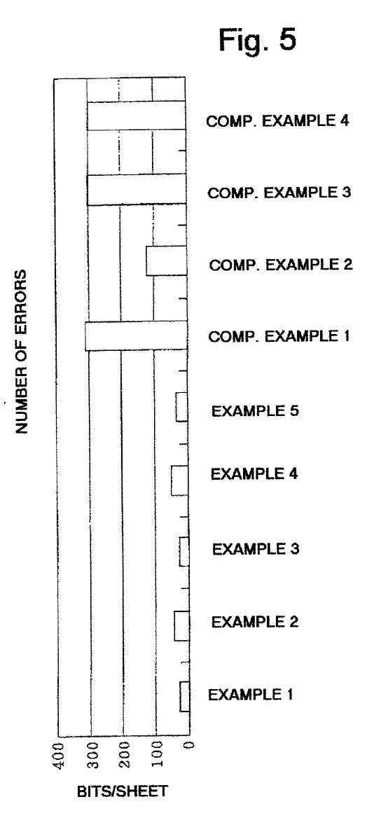

The result of the measurement of the number of errors is shown in FIG. 5.

The numbers of errors on the magnetic recording media of Examples 1 through 5, which use substrates cleaned according to the invention, were substantially less than those of Comparative Examples 1 through 4. The large numbers of errors in Comparative Examples 1 and 2 are caused by the latent flaws, and the large numbers of errors in Comparative Examples 3 and 4 are caused by particles remaining on the surface of the substrate.

Summary

The evaluation results described above are summarized in Table 4.

TABLE 4
Summary of evaluations

| | | surface | | | | |
|---|---|---|---|---|---|---|
| | | compo- | cleaning | latent | no. of | overall |
| | etching | sition | ability | flaws | errors | evaluation |
| Example 1 | no | un- | excel- | excel- | excel- | excel- |
| | | changed | lent | lent | lent | lent |
| Example 2 | no | un- | excel- | excel- | excel- | excel- |
| | | changed | lent | lent | lent | lent |
| Example 3 | no | un- | excel- | excel- | excel- | excel- |
| | | changed | lent | lent | lent | lent |
| Example 4 | no | un- | excel- | excel- | excel- | excel- |
| | | changed | lent | lent | lent | lent |
| Example 5 | no | un- | excel- | excel- | excel- | excel- |
| | | changed | lent | lent | lent | lent |
| Comp. | yes | alkali | not | poor | poor | poor |
| Example 1 | | dis- | good | | | |
| | | solved | | | | |
| Comp. | yes | alkali | fair | poor | not | poor |
| Example 2 | | dis- | | | good | |
| | | solved | | | | |
| Comp. | no | un- | poor | excel- | poor | poor |
| Example 3 | | changed | | lent | | |
| Comp. | no | un- | poor | excel- | poor | poor |
| Example 4 | | changed | | lent | | |

Examples 1 through 5 showed little or no etching effect. However, the surfaces thereof were cleaned sufficiently so that few particles remained on the surface after cleaning and few latent flaws were observed.

Hydrofluoric acid and hydrosilicofluoric acid used in Comparative Examples 1 and 2 have etching effect, and consequently have cleaning ability. However, inhomogeneous dissolution occurs on the glass surface along locations with microscopic inhomogeneous composition, thereby generating latent flaws. The flaws adversely affect film deposition, resulting in an increased number of errors.

The acids used in Comparative Examples 3 and 4 dissolve the glass component very little and have no etching effect. Consequently, these acids do not generate latent flaws. However, the cleaning ability of these acids is so little that a large number of particles remained after cleaning, resulting in increased number of errors.

Effect of the invention

As described so far, the present invention provides a method for cleaning a glass substrate after the polishing step. The method eliminates the abrasive grains and the polishing powder without etching the substrate surface, to obtain a substrate for a magnetic recording medium, in which no latent flaws are generated and very few particles remain attached. A magnetic recording medium using such a substrate is of high quality with very few errors quality.

It will be noted that oxygen is generated at the anode of an electrolysis apparatus. It is believed that a substantial amount of this oxygen is absorbed by the water to have the recited cleaning effect. Oxygen is most usually found as two atoms of oxygen joined into a molecule. Ozone is a tri-atomic form of oxygen. Thus, each of the embodiments of the invention relies on the presence of atoms of oxygen in the cleaning water.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for cleaning a glass substrate for a magnetic recording medium comprising washing said glass substrate in anode water that is produced in an anode side by electrolysis of pure water having a resistivity of at least 10 MΩ-cm.

2. A method for cleaning a glass substrate according to claim 1, wherein said anode water includes an electrolyte selected from a group consisting of hydrochloric acid, sulfuric acid, nitric acid, phosphoric acid, malic acid, citric acid, and succinic acid in a concentration of greater than zero and not more than 100 mM.

3. A method for cleaning a glass substrate for a magnetic recording medium comprising:
washing said substrate in pure water having a resistivity of at least 10 MΩ-cm; and
said pure water containing a substance selected from oxygen and ozone in a concentration of from 0.1 ppm to 10,000 ppm.

4. A glass substrate for a magnetic recording medium that is cleaned by the method for cleaning defined by claim 1.

5. A glass substrate for a magnetic recording medium that is cleaned by the method for cleaning defined by claim 3.

6. A magnetic recording medium comprising:
a glass substrate according to claim 5;
at least a magnetic layer and a protective layer sequentially formed on said glass substrate; and
a liquid lubricant layer on said protective layer.

7. A magnetic recording medium comprising:
a glass substrate according to claim 4;
at least a magnetic layer and a protective layer sequentially formed on said glass substrate; and
a liquid lubricant layer on said protective layer.

8. A method for cleaning a glass substrate for a magnetic recording medium comprising:
producing anode water at an anode side of an electrolysis apparatus using water having a resistivity of at least 10 MΩ-cm;
adding an electrolyte to said water;
said electrolyte being selected from the group consisting of hydrochloric acid, sulfuric acid, nitric acid, phosphoric acid, malic acid, citric acid, and succinic acid in a concentration of not more than about 100 mM after said electrolysis; and
washing said glass substrate with said anode water.

9. A method for cleaning a glass substrate for a magnetic recording medium comprising:
producing an anode water at an anode side of an electrolysis apparatus;
said anode water having a resistivity of at least 10 MΩ-cm;
adding an electrolyte to said water;
said electrolyte being selected from the group consisting of hydrochloric acid, sulfuric acid, nitric acid, phosphoric acid, malic acid, citric acid, and succinic acid in a concentration of not more than about 100 mM after said electrolysis; and
washing said glass substrate with said anode water.
